(19) United States
(12) Patent Application Publication
(10) Pub. No.: US 2013/0256088 A1
(43) Pub. Date: Oct. 3, 2013

(54) ARC SPRING AND DAMPER APPARATUS

(71) Applicant: AISIN AW INDUSTRIES CO., LTD., Echizen-shi (JP)

(72) Inventors: Katsunori Tanaka, Echizen-shi (JP); Hideki Seki, Echizen-shi (JP)

(73) Assignee: AISIN AW INDUSTRIES CO., LTD., Echizen-shi (JP)

(21) Appl. No.: 13/849,600

(22) Filed: Mar. 25, 2013

(30) Foreign Application Priority Data
Mar. 27, 2012 (JP) 2012-071427

(51) Int. Cl. F16D 13/58

(52) U.S. Cl. CPC F16D 13/58
USPC 192/203

(57) ABSTRACT

A spring retaining space that retains therein an arc spring has a predetermined curvature radius and attachment angle. The arc spring is flexed and retained in the spring retaining space, and thus the curvature radius of the arc spring becomes small, while the attachment angle of the arc spring becomes larger than a free angle. Accordingly, torsion stress with a negative sign is applied to a coil member forming the inner circumferential portion of the arc spring.

### BACKGROUND OF THE INVENTION

The present invention relates to an arc spring and a damper apparatus.

Springs are formed by spirally winding a coil member. Springs are compressed by load acting on the axial direction of the springs. In the case of a straight cylindrical spring, the torsion level of the coil member produced originating from the compression of the spring is uniform. In the case of a curved arc spring, however, the torsion level of the coil member produced originating from the compression of the arc spring is nonuniform. In the latter case, the stroke level of the outer circumferential portion of the arc spring is larger than that of the inner circumferential portion of the arc spring. Hence, the torsion stress and distortion of the coil member forming the inner circumferential portion of the arc spring are both large. That is, the stroke level of the outer circumferential portion of the arc spring depends on the distortion of the coil member forming the inner circumferential portion of the arc spring.

FIG. 1A illustrates a conventional arc spring retained in a spring retaining space. FIG. 1B illustrates a conventional arc spring that is compressed in the spring retaining space and that has a compression angle that is θ. An arc spring has a reference radius R₁, an average diameter D₀, and a free angle θ₀. Moreover, a spring retaining space has an attachment radius R₁ and an attachment angle θ₀. That is, the arc spring has the same size and shape as those of the spring retaining space. As illustrated in FIG. 1C, the average diameter D₀ of the arc spring indicates a distance between the center of the coil member forming the inner circumferential portion of the arc spring and the center of the coil member forming the outer circumferential portion of the arc spring. In order to eliminate any backlash of the arc spring in the spring retaining space, the attachment angle of the spring retaining space may be set smaller than the free angle θ₀ of the arc spring. In this case, with initial load being applied to the arc spring, the arc spring is retained in the spring retaining space.

When the compression angle of the arc spring is (θ) and the stroke level thereof is (δ), it can be expressed that:

Attachment radius stroke δ=θ×R₁;

Outer circumference stroke δₒᵤₜ=θ×(R₁+D₀/2); and

Inner circumference stroke δᵢₙ=θ×(R₁−D₀/2).

FIG. 2 illustrates a relationship between a compression angle θ of the arc spring and a torsion stress of the coil member inherent to the compression of the arc spring. It becomes clear from FIG. 2 that the torsion stress of the coil member forming the inner circumferential portion of the arc spring is relatively large, while the torsion stress of the coil member forming the outer circumferential portion of the arc spring is relatively small. This is because the stroke level of the outer circumferential portion of the arc spring depends on the torsion of the coil member forming the inner circumferential portion of the arc spring. Hence, when the arc spring is repeatedly compressed, a fatigue breakdown is likely to occur at the inner circumferential portion of the arc spring rather than the outer circumferential portion of the arc spring. That is, conventional arc springs are not configured to effectively absorb impact torque through the whole coil member.

The above-explained arc spring is utilized as a damper spring of a damper apparatus. FIG. 3 illustrates a conventional and typical torque converter. FIG. 4 illustrates a damper apparatus configuring the torque converter. As illustrated in FIG. 3, the torque converter includes, in a casing 105, a pump impeller 101, a turbine runner 102, a stator 103, and a piston 104. When a front cover 106 rotates by power from an engine, the pump impeller 101 rotates together with the front cover 106, and the turbine runner 102 rotates with an actuation fluid being as a medium.

Attached at the inner circumferential portion of the turbine runner 102 is a turbine hub 107. Moreover, the turbine hub 107 is engaged with an unillustrated input shaft that transmits power to a transmission. Accordingly, the rotation of the turbine runner 102 can be transmitted to the unillustrated transmission. Since the torque converter is a fluid coupling, when the rotation speed of the pump impeller 101 is slow, the rotation of the turbine runner 102 is terminated, thereby stopping a vehicle. Conversely, when the rotation speed of the pump impeller 101 becomes fast, the turbine runner 102 starts rotating. Next, when the rotation speed of the pump impeller 101 becomes further fast, the speed of the turbine runner 102 becomes close to the rotation speed of the pump impeller 101. However, the rotation speed of the turbine runner 102 that rotates with an actuation fluid being as a medium does not become consistent with the rotation speed of the pump impeller 101.

With respect to this point, as illustrated in FIG. 3, located in the casing 105 is the piston 104. When the rotation speed of the turbine runner 102 exceeds a predetermined range, the piston 104 moves in the axial direction, and is engaged with the front cover 106. A friction member 108 is attached to an outer circumferential portion of the piston 104. Hence, the piston 104 does not slip against the front cover 106, and can rotate at the same speed as that of the front cover 106. Moreover, the piston 104 is coupled with the turbine hub 107 through a damper 111. Accordingly, the turbine runner 102 directly rotates by the piston 104, while at the same time, power from the engine is transmitted to the transmission without loss through the fluid. That is, the power from the engine can be transmitted to the transmission at a high efficiency that is substantially 100% without a loss due to a transmission through the fluid.

As explained above, when the rotation speed of the turbine runner 102 becomes fast and satisfies a predetermined condition, the piston 104 is engaged with the front cover 106. However, the rotation speed of the turbine runner 102 is not completely consistent with the rotation speed of the front cover 106 right before the piston 104 is engaged with the front cover 106. Hence, when the piston 104 is engaged with the front cover 106, a shock occurs due to a difference between the rotation speed of the piston 104 and that of the front cover 106. It is necessary to ease the shock occurring at this time, and to suppress a transmission of the torque variation of the engine after the engagement. Accordingly, provided between the piston 104 and the turbine runner 102 is a damper apparatus 111 including a plurality of straight and cylindrical springs 110.

According to the above-explained embodiment, the piston 104 that rotates together with the turbine runner 102 is engaged with the front cover 106 that rotates at a slightly faster rotation speed than that of the piston 104. At this time, impact torque acting on the piston 104 is eased by the compressed straight and cylindrical springs 110. The piston 104 is located coaxially with the turbine hub 107, and is attached to the turbine hub 107. Moreover, the piston 104 is rotatable relative to the turbine runner 102 by the compressed straight and cylindrical springs 110.

FIG. 4 illustrates a conventional damper apparatus 111. The damper apparatus 111 includes a center disk 120 at an input side. The center disk 120 includes plates 121 and 122 located at the first face and the second face, respectively, which are output sides. The plates 121 and 122 are each formed with spring retaining spaces 124 for retaining the straight and cylindrical springs 110. Moreover, the center disk 120 is also formed with spring retaining spaces 124 for retaining the straight and cylindrical springs 110. Two straight and cylindrical springs 110 are located as a set in the spring retaining space 124 in the center disk 120. A spring holder 125 is formed at each of both ends of the spring retaining space 124. The straight and cylindrical springs 110 are located in series between adjoining spring holders 125. A separator 127 that protrudes outwardly from an intermediate member 126 is located between the two straight and cylindrical springs 110. The center disk 120 and the plates 121 and 122 configure the main portion of the damper apparatus 111.

The plate 122 has an inner circumferential portion 122a fastened to the turbine hub 107 by rivets together with the turbine runner 102. Hence, impact torque caused when the piston 104 is engaged with the front cover 106 is transmitted to the center disk 120. Next, the straight and cylindrical springs 110 in the spring retaining space 124 are compressed by the spring holder 125 of the center disk 120. When, for example, the center disk 120 rotates clockwise, the straight and cylindrical springs 110 in the spring retaining space 124 are depressed by the spring holder 125. In this case, ends of the spring retaining spaces 124 of the plates 121 and 122 serves as spring receivers 128.

As explained above, the two straight and cylindrical springs 110 as a set are retained in the spring retaining space 124. Moreover, the separator 127 is located between the two straight and cylindrical springs 110. Hence, the intermediate member 126 rotates together with compression of the straight and cylindrical springs 110. Accordingly, both of the straight and cylindrical springs 110 are compressed uniformly.

Moreover, since the straight and cylindrical springs 110 are located in series, it becomes possible to let the straight and cylindrical springs 110 compress greatly, and thus large impact torque can be eased. Furthermore, it becomes possible to absorb relatively small torque vibration. Accordingly, the torque vibration of the engine having the piston 104 engaged with the front cover 106 can be absorbed.

According to the damper apparatus 111 illustrated in FIG. 4, one straight and cylindrical spring 110 is present between both ends of the intermediate member 126, and thus the two straight and cylindrical springs 110 as a set are located in series. According to such a structure, when a long arc spring is used instead of the two straight and cylindrical springs 110 as a set, the separator 127 becomes unnecessary, and the compression stroke of the arc spring increases. Accordingly, the arc spring can absorb further larger impact torque, and the compression stroke of the arc spring can be increased, but the torsion stress of the coil member configuring the arc spring is nonuniform. More specifically, the torsion stress of the coil member forming the outer circumferential portion of the arc spring is relatively small, while the torsion stress of the coil member forming the inner circumferential portion of the arc spring is relatively large. As a result, the torsion stress of the coil member forming the inner circumferential portion of the arc spring is likely to exceed the tolerance.

### SUMMARY OF THE INVENTION

It is an object of the present invention to provide an arc spring and a damper apparatus which suppresses the torsion stress of a coil member forming the inner circumferential portion of an arc spring to allow the arc spring to be compressed at a larger stroke and to absorb large impact torque.

According to an aspect of the present invention, the arc spring has predetermined curvature radius Rₐ and free angle θₐ in a free condition. The spring retaining space that retains thereinside the arc spring has predetermined curvature radius R₁ and attachment angle θ₀. The relationship that: the curvature radius Rₐ of the arc spring>the curvature radius R₁ of the spring retaining space and the relationship that: the free angle θₐ of the arc spring<the attachment angle θ₀ of the spring retaining space are satisfied. That is, the arc spring of the present invention is flexed and then retained in the spring retaining space.

### BRIEF DESCRIPTION OF THE DRAWINGS

FIG. 1A is an exemplary diagram illustrating a conventional arc spring retained in a spring retaining space;

FIG. 1B is an exemplary diagram illustrating a condition in which the arc spring is compressed by a compression angle θ;

FIG. 1C is an exemplary diagram illustrating a general structure of the arc spring;

FIG. 2 is a graph illustrating a relationship between a compression angle and torsion stress applied to the coil member of an arc spring when the conventional arc spring is compressed;

FIG. 3 is an exemplary diagram illustrating a general structure of a torque converter;

FIG. 4 is an exemplary diagram illustrating a general structure of a damper apparatus applied to the torque converter;

FIG. 5A is an exemplary diagram illustrating an arc spring in a free condition;

FIG. 5B is an exemplary diagram illustrating a condition in which the arc spring in a free condition illustrated in FIG. 5A is flexed and retained in a spring retaining space;

FIG. 6 is an exemplary diagram illustrating the arc spring in the spring retainer space compressed by a compression angle θ;

FIG. 7 is a graph illustrating a relationship between the compression angle of an arc spring of the present invention and torsion stress;

FIG. 8 is a line drawing of conventional damper compression rigidity;

FIG. 9 is a line drawing of damper compression rigidity according to the present invention with an improved torque;

FIG. 10 is a line drawing of damper compression rigidity according to the present invention with an improved stroke;

FIG. 11 is a graph illustrating torsion stress applied to the coil member of an arc spring when the arc spring having a curvature radius R₁ is retained in the spring retaining space having a curvature radius R₁;

FIG. 12 is a graph illustrating torsion stress applied to the coil member of an arc spring when the arc spring having a curvature radius Rₐ is retained in a spring retaining space having a curvature radius R₁;

FIG. 13 is a graph illustrating a relationship between a curvature radius of an arc spring and torsion stress applied to a coil member when the arc spring is retained in a spring retaining space having a curvature radius R₁;

FIG. 14 is a graph illustrating torsion stress applied to the coil member of an arc spring when the arc spring having a curvature radius a is retained in a spring retaining space having a curvature radius R₁;

FIG. 15 is a graph illustrating torsion stress applied to the coil member of an arc spring when the arc spring having a curvature radius b is retained in a spring retaining space having a curvature radius R₁;

FIG. 16 is a graph illustrating torsion stress applied to the coil member of an arc spring when the arc spring having a curvature radius c is retained in a spring retaining space having a curvature radius R₁; and

FIG. 17 is an exemplary diagram illustrating a condition in which an arc spring is retained in a spring retaining space and the arc spring is held by a spring holder and a spring receiver.

### DESCRIPTION OF THE PREFERRED EMBODIMENTS

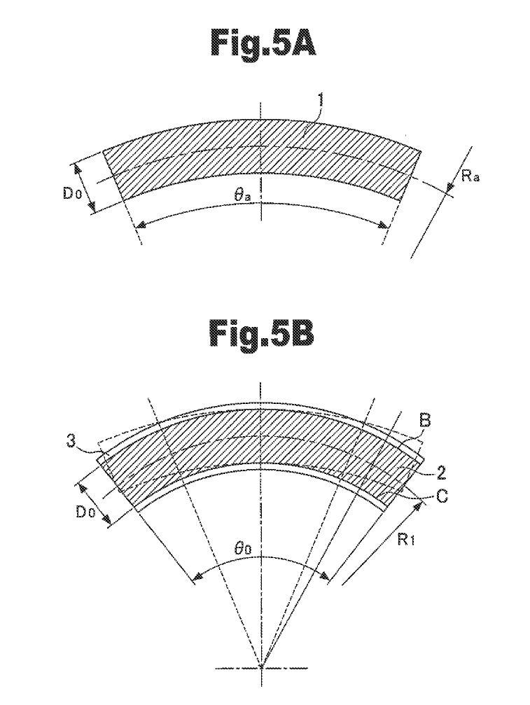

An explanation will now be given of an embodiment that substantiates an arc spring of the present invention and a damper apparatus thereof with reference to FIGS. 5A to 17.

FIG. 5A illustrates an arc spring 1 in a free condition. FIG. 5B illustrates an arc spring 2 retained in a spring retaining space 3. As illustrated in FIG. 5A, the arc spring 1 has an average diameter D₀, a reference radius Rₐ that is a predetermined curvature radius, and a free angle θₐ. Conversely, the spring retaining space 3 has a reference radius (attachment diameter) R₁ that is a predetermined curvature radius and an attachment angle θ₀. That is, the arc spring 1 has a different curvature radius from that of the spring retaining space 3. Hence, the arc spring 1 is flexed from a free condition and is retained in the spring retaining space 3. Dot lines in FIG. 5B indicate the arc spring 1 in a free condition. The arc spring 2 retained in the spring retaining space 3 has the curvature radius R₁. A relationship Rₐ×θₐ=R₁×θ₀ is satisfied when the arc spring 1 is retained in the spring retaining space 3 in this manner. Accordingly, the arc spring 1 is manufactured so as to satisfy the relationship that curvature radius Rₐ=R₁×θ₀/θₐ.

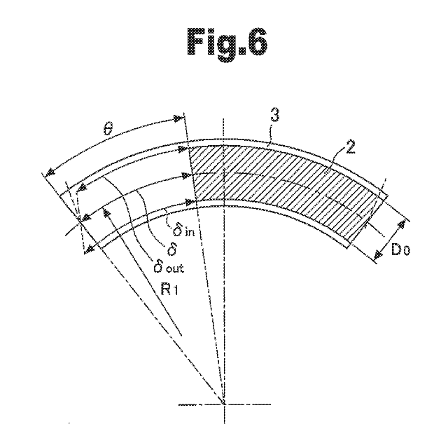

FIG. 6 illustrates a condition in which the arc spring 2 in the spring retaining space 3 is compressed by a compression angle θ. According to the present invention, the arc spring 1 is flexed and then retained in the spring retaining space 3. Accordingly, torsion stress with a negative sign is applied to a coil member forming the inner circumferential portion of the arc spring 1. Hence, as illustrated in FIG. 6, when the arc spring 2 is compressed by the compression angle θ, torsion stress with a positive sign acting on the coil member forming the inner circumferential portion of the arc spring 2 is eased by the torsion stress with a negative sign applied to the coil member in advance.

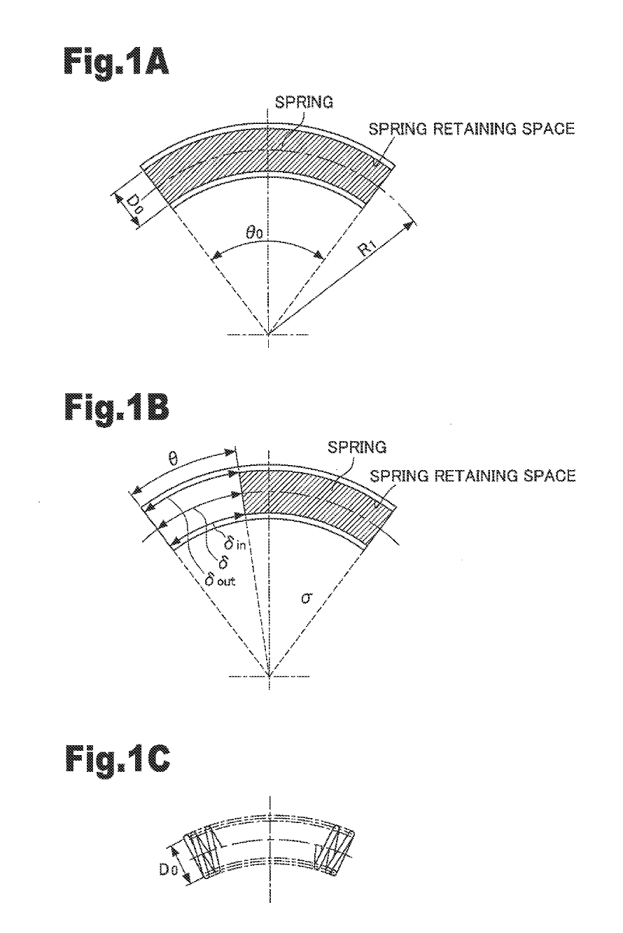

As illustrated in FIG. 1, with respect to a stroke level of a conventional arc spring when compressed by a compression angle θ, it can be expressed that:

Reference diameter stroke δ=θ×R₁;

Outer circumference stroke δₒᵤₜ=(R₁+D₀/2)×θ; and

Inner circumference stroke δᵢₙ=(R₁−D₀/2)×θ.

A compression stroke level is longer than the reference diameter stroke by (D₀/2×θ) at the outer circumferential portion of the arc spring 2, and is shorter than the reference diameter stroke by (D₀/2×θ) at the inner circumferential portion of the arc spring 2. Hence, when the arc spring 1 is flexed and is retained in the spring retaining space 3, if the outer circumferential portion of the arc spring 2 is elongated by (D₀/2×θ) and the inner circumferential portion of the arc spring 2 is compressed by (D₀/2×θ), stress caused when the arc spring 2 is compressed can be uniform across the whole arc spring 2.

When the reference diameter of the arc spring 1 is Rₐ and the free angle thereof is θₐ, it can be expressed that:

Reference arc length: θₐ×Rₐ=θ₀×R₁;

Outer circumference arc length: θₐ×(Rₐ+D₀/2)=B−(θ×D₀/2), i.e., θₐ×(Rₐ+D₀/2)=θ₀×(R₁+D₀/2)−(θ×D₀/2); and

Inner circumference arc length: θₐ×(Rₐ−D₀/2)=C+(θ×D₀/2), i.e., θₐ×(Rₐ−D₀/2)=θ₀×(R₁−D₀/2)+(θ×D₀/2)

From those equations, it can be obtained that:

Rₐ=θ₀×R₁/(θ₀−θ); and

θₐ=θ₀−θ

The shape of the arc spring 1 can be defined so as to satisfy those conditions. Note that B is a length of an outer circumference portion of the spring retaining space and C is a length of an inner circumference portion of the spring retaining space.

As explained above, the arc spring 1 is retained in the spring retaining space 3 after the above-explained conditions are satisfied. In this case, as illustrated in FIG. 6, when the arc spring 1 is compressed by the compression angle θ, the stroke level of the arc spring becomes as follows:

Attachment diameter stroke δ=θ×R₁;

Outer diameter stroke δₒᵤₜ=θ×R₁; and

Inner diameter stroke δᵢₙ=θ×R₁.

That is, when the arc spring 1 is flexed and is retained in the spring retaining space 3, the outer circumferential portion of the arc spring 2 is elongated by (D₀/2×θ), and the inner circumferential portion of the arc spring 2 is compressed by (D₀/2×θ). Moreover, as illustrated in FIG. 6, when the arc spring 2 is compressed in the spring retaining space 3, the compression stroke level at the outer circumferential portion of the arc spring 2 becomes larger than the reference diameter stroke by (D₀/2×θ), and the compression stroke level at the inner circumferential portion of the arc spring 2 becomes smaller than the reference diameter stroke by (D₀/2×θ). This makes the stress produced when the arc spring 2 is compresses uniform across the whole arc spring 2.

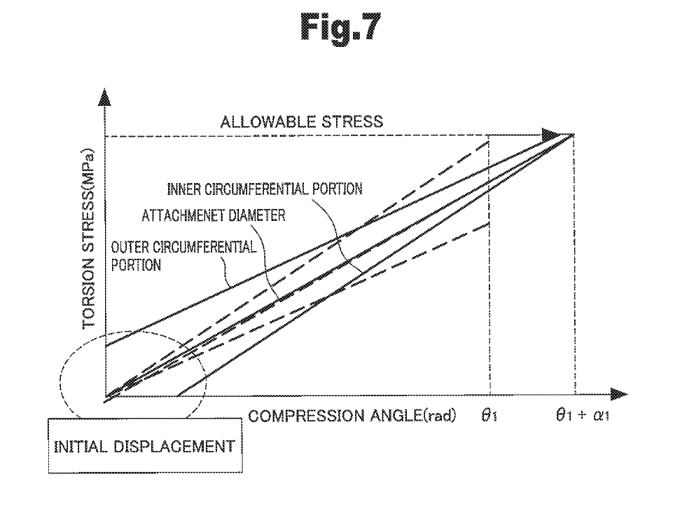

FIG. 7 illustrates a relationship between a compression angle θ and a torsion stress of the coil member when the arc spring 2 of the present invention is retained in the spring retaining space 3 and compressed. Torsion stress with a negative sign is applied in advance to the coil member forming the inner circumferential portion of the arc spring 2. Moreover, torsion stress with a positive sign is applied in advance to the coil member forming the outer circumferential portion of the arc spring 2. As illustrated in FIG. 7, as the arc spring 2 in the spring retaining space 3 is compressed, the torsion stress acting on the coil member configuring the arc spring 2 increases. Next, when the compression angle of the arc spring 2 reaches θ₁+α₁, the torsion stress at the attachment diameter, the torsion stress of the coil member forming the inner circumferential portion of the arc spring 2, and the torsion stress of the coil member forming the outer circumferential portion of the arc spring 2 become consistent with each other.

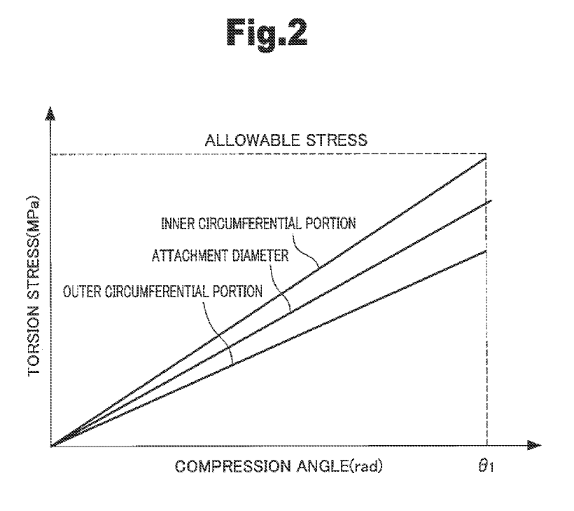

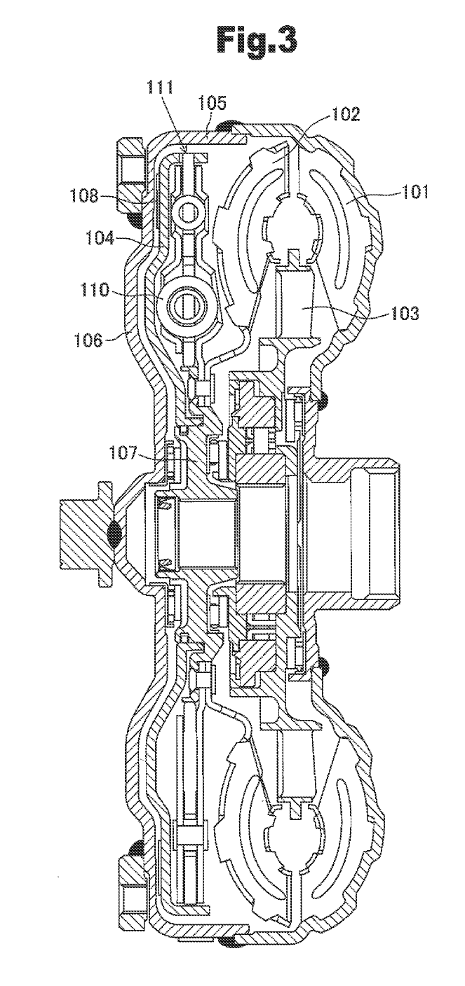

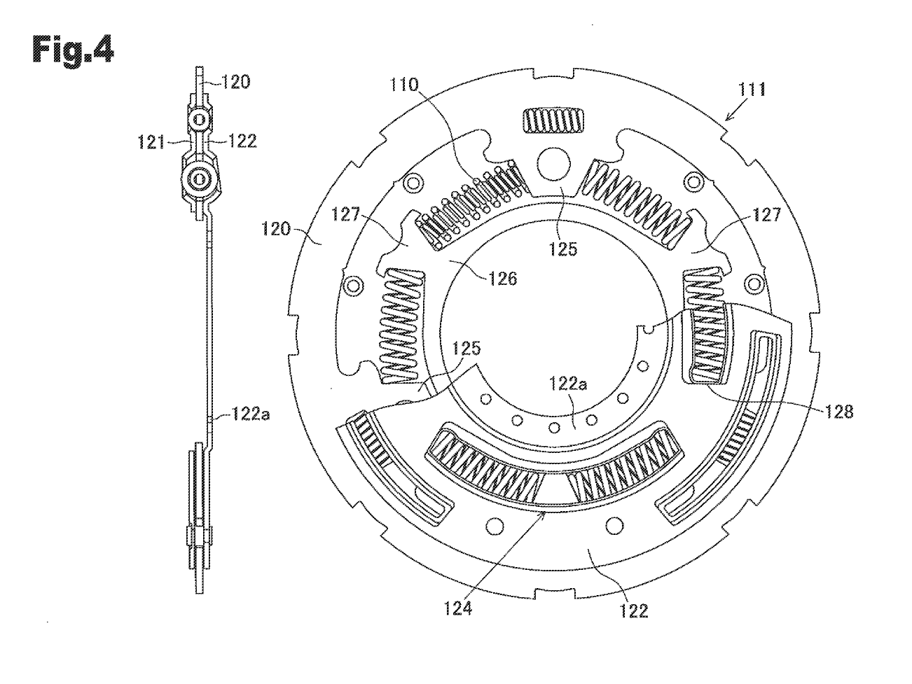

As illustrated in FIGS. 2 and 7, the ratio of the increase of the torsion stress acting on the coil member forming the inner circumferential portion of the arc spring 2 relative to the compression angle is relatively large. With respect to this point, according to the present invention, torsion stress with a negative sign is applied in advance to the coil member forming the inner circumferential portion of the arc spring 2. Hence, when the compression angle of the arc spring 2 reaches θ₁+α₁, the torsion stress at the attachment diameter and the torsion stress of the coil member forming the inner circumferential portion of the arc spring 2 become consistent with each other. Conversely, the ratio of the increase of the torsion stress of the coil member forming the outer circumferential portion of the arc spring 2 relative to the compression angle is relatively small. With respect to this point, according to the present invention, torsion stress with a positive sign is applied in advance to the coil member forming the outer circumferential portion of the arc spring 2. Accordingly, when the compression angle of the arc spring 2 reaches θ₁+α₁, the torsion stress of the attachment diameter and the torsion stress of the coil member forming the outer circumferential portion of the arc spring 2 become consistent with each other.

In FIG. 7, dot lines indicate torsion stress of the coil member produced when a conventional arc spring is compressed. According to a conventional structure, no torsion stress is applied in advance to the coil member of each portion of the arc spring. Accordingly, when the torsion stress of the coil member forming the inner circumferential portion of the arc spring, the torsion stress at the attachment diameter, and the torsion stress of the coil member forming the outer circumferential portion of the arc spring increase in proportional to the compression angle, the torsion stress of the coil member forming the inner circumferential portion of the arc spring becomes larger than the torsion stress acting on the coil member of the other portions, and becomes the same value as the allowable stress when the compression angle reaches θ₁.

Conversely, according to the present invention, torsion stress with a negative sign is applied in advance to the coil member forming the inner circumferential portion of the arc spring 2. Hence, when the arc spring 2 is largely compressed and torsion stress is increased to the allowable stress, as illustrated in FIG. 7, the compression angle corresponding to the allowable stress can be increased to an angle larger than θ₁. That is, by applying the stress with a negative sign in advance to the coil member forming the inner circumferential portion of the arc spring 2, the compression angle corresponding to the allowable stress can be increased up to (θ₁+α₁).

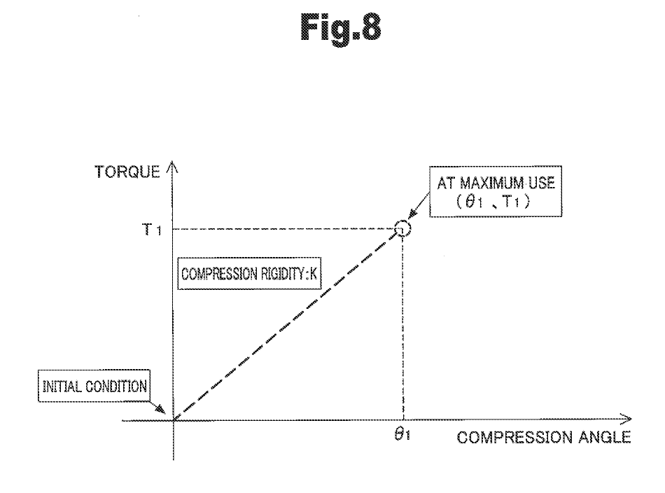

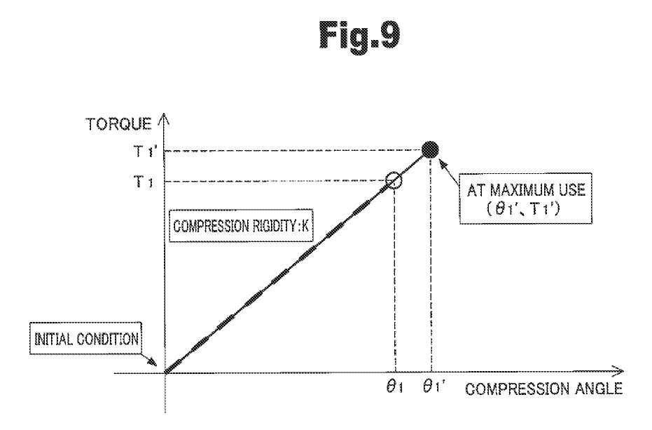

FIG. 8 is a line drawing of conventional damper compression rigidity. The torque at a compression angle θ₁ that is the allowable stress of the arc spring is T₁. FIG. 9 is a line drawing of a damper compression rigidity of a damper apparatus including the arc spring 2 of the present invention. According to the present invention, when a compression rigidity K is the same as that of the conventional structure, a compression angle θ₁′ becomes larger than the compression angle θ₁, and an allowable torque T₁′ becomes also larger than the allowable torque T₁.

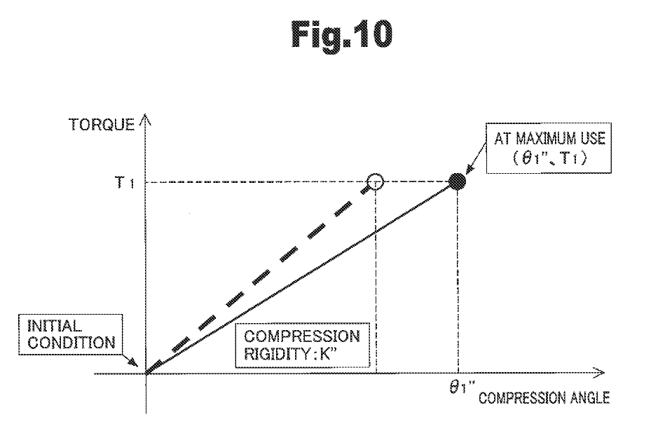

FIG. 10 is a line drawing of a damper compression rigidity of a damper apparatus including the arc spring 2 of the present invention, and illustrates a case in which stroke is improved at a low-compression rigidity. When a necessary torque of the damper apparatus of the present invention is set to be T₁ like the damper apparatus including the conventional arc spring, a compression angle θ₁″ increases, and thus large impact torque can be eased. As explained above, according to the damper apparatus using the arc spring 2 of the present invention, absorption energy increases, the torque of the damper apparatus increases, and the stroke level that can permit the arc spring to be compressed also increases.

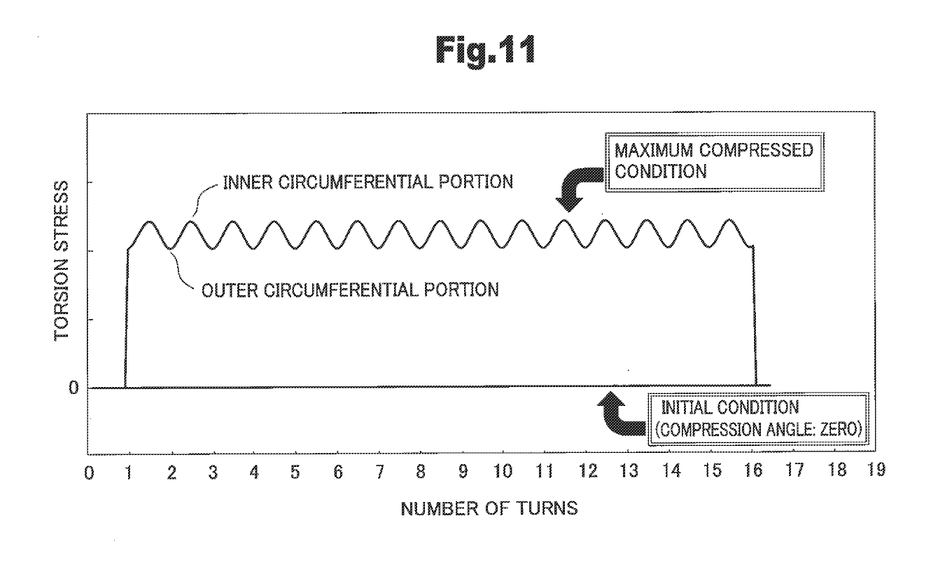

FIG. 11 illustrates torsion stresses acting on the coil member of the arc spring in the initial condition of the arc spring and in the maximum compression condition thereof. Moreover, FIG. 11 illustrates torsion stress of the coil member produced when the conventional arc spring illustrated in FIG. 1 is retained in a spring retaining space having the same curvature radius as that of the arc spring which is R₁. When the arc spring flexed to a predetermined curvature radius R₁ is compressed, as illustrated in FIG. 11, stress in a waveform is applied to the arc spring so as to correspond to the number of turns of the arc spring. In this case, the torsion stress of the coil member forming the inner circumferential portion of the arc spring is relatively large, while the torsion stress of the coil member forming the outer circumferential portion of the arc spring is relatively small.

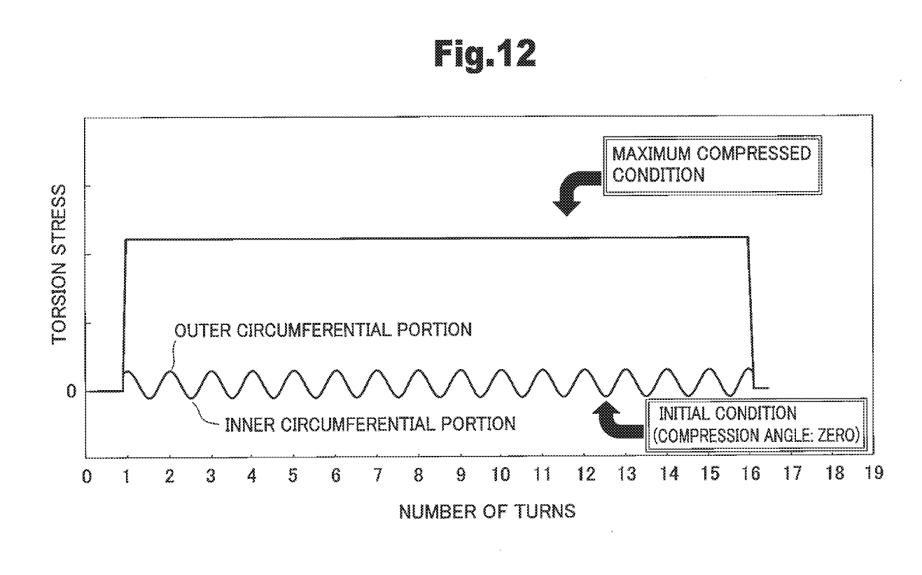

In contrast, FIG. 12 illustrates torsion spring of the coil member produced when the arc spring 2 of the present invention is retained in the spring retaining space 3. In this case, the arc spring 1 having a predetermined curvature radius Rₐ is further flexed, and is retained in the spring retaining space 3 having a curvature radius of R₁. Hence, in the initial condition of the arc spring 2, initial torsion stress in a waveform acts on the arc spring 2 so as to correspond to the number of turns of the arc spring 2. The bottom of the waveform corresponds to the torsion stress of the coil member forming the inner circumferential portion of the arc spring 2, while the top of the waveform corresponds to the torsion stress of the coil member forming the outer circumferential portion of the arc spring 2.

According to the present invention, when the arc spring 2 to which the initial torsion stress is applied is compressed to a predetermined angle, the torsion stress applied to the coil member of the arc spring 2 becomes constant across the whole arc spring 2. That is, as illustrated in FIG. 7, when the compression angle of the arc spring 2 reaches θ₁+α₁, the torsion stress at the attachment diameter, the torsion stress of the coil member forming the inner circumferential portion of the arc spring 2 and the torsion stress of the coil member forming the outer circumferential portion of the arc spring 2 indicate the same value.

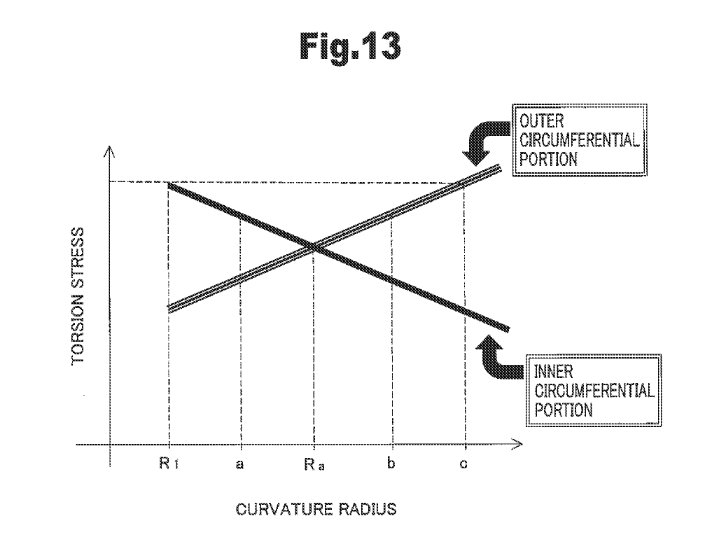

FIG. 13 illustrates torsion stress of the coil member produced when the arc spring 1 is retained in the spring retaining space 3 having a curvature radius R₁ and compressed with the curvature radius of the arc spring 1 being as R₁, a, Rₐ, b, and c (R₁<a<Rₐ<b<c). As illustrated in FIG. 11, when the curvature radius of the arc spring 1 is set to be R₁, in the initial condition of the arc spring 2, the torsion stress of the coil member at both of the inner circumferential portion of the arc spring 2 and the outer circumferential portion thereof is zero. Conversely, when the arc spring 2 is compressed, torsion stress is applied to the coil member configuring the arc spring 2. In contrast, as illustrated in FIG. 12, when the curvature radius of the arc spring 1 is set to be Rₐ, in the initial condition of the arc spring 2, initial stress is applied to the coil member at both of the inner circumferential portion of the arc spring 2 and the outer circumferential portion thereof. Conversely, in the compressed condition of the arc spring 2, the torsion stress of the coil member applied to the inner circumferential portion of the arc spring 2 and the outer circumferential portion thereof becomes equal.

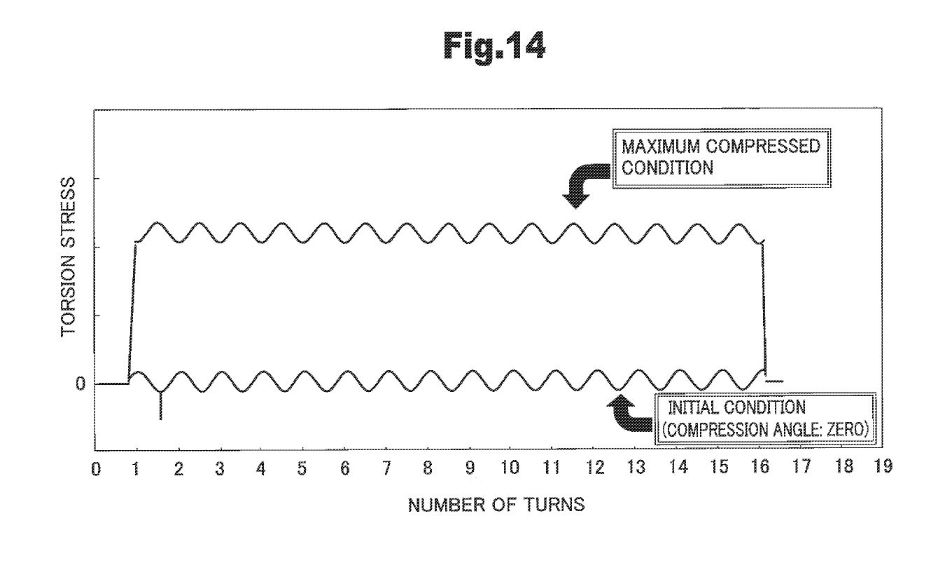

FIG. 14 illustrates torsion stress of the coil member produced when the arc spring 1 has the curvature radius that is a, the curvature radius a satisfies a relationship that R₁<a<Rₐ, and the arc spring 1 having the curvature radius of a is retained in the spring retaining space 3 having a curvature radius of R₁. In this case, the arc spring 1 is flexed so as to be smaller than the case illustrated in FIG. 12, and is retained in the spring retaining space 3 having a curvature radius of R₁. Hence, in the initial condition of the arc spring 2, initial torsion stress in a waveform corresponding to the number of turns of the arc spring 2 is applied to the arc spring 2. Moreover, in the compressed condition of the arc spring 2, torsion stress is applied to the coil member configuring the arc spring 2.

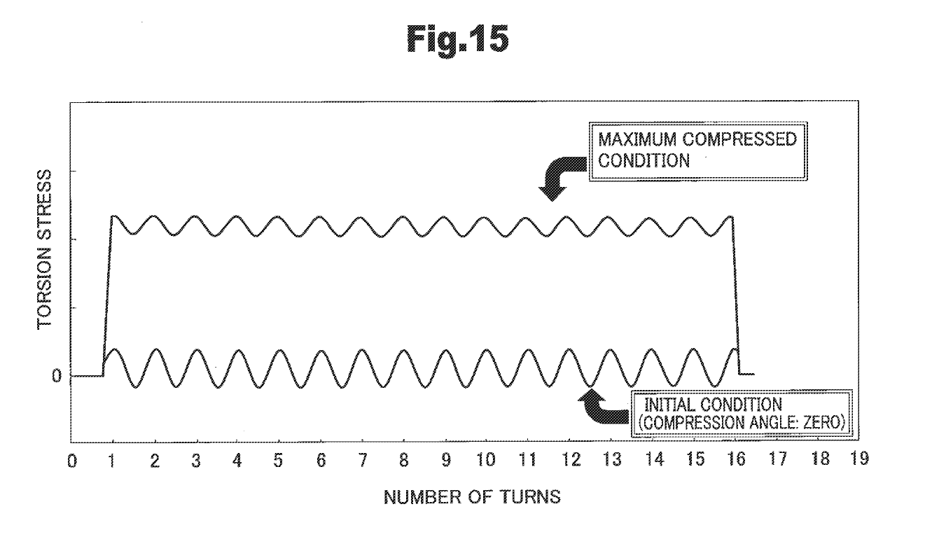

FIG. 15 illustrates torsion stress of the coil member produced when the arc spring 1 has a curvature radius of b, the curvature radius b satisfies a relationship that Rₐ<b, and the arc spring 1 having the curvature radius of b is retained in the spring retaining space 3 having a curvature radius of R₁. In this case, in the initial condition of the arc spring 2, torsion stress larger than the cases of FIGS. 12 and 14 is applied to the coil member configuring the arc spring 2. Moreover, in the compressed condition of the arc spring 2, torsion stress is also applied to the coil member configuring the arc spring 2. In this case, since the curvature radius satisfies a relationship that Rₐ<b, in the compressed condition of the arc spring 2, the torsion stress of the coil member forming the outer circumferential portion of the arc spring 2 becomes larger than the torsion stress of the coil member forming the inner circumferential portion of the arc spring 2.

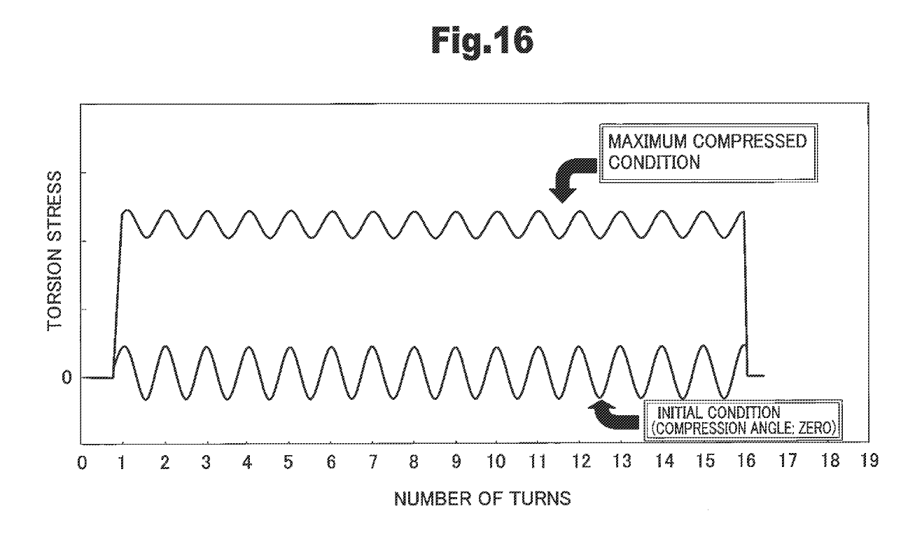

FIG. 16 illustrates torsion stress of the coil member produced when the arc spring 1 has a curvature radius of c, the curvature radius c satisfies a relationship that Rₐ<b<c, and the arc spring 1 having the curvature radius of c is retained in the spring retaining space 3 having a curvature radius of R₁. As illustrated in FIG. 16, in the initial condition of the arc spring 2, further larger torsion stress than the case of FIG. 15 is applied to the coil member configuring the arc spring 2. Moreover, in the compressed condition of the arc spring 2, torsion stress is also applied to the coil member configuring the arc spring 2. In this case, since the curvature radius satisfies a relationship that Rₐ<b<c, in the compressed condition of the arc spring 2, the torsion stress of the coil member forming the outer circumferential portion of the arc spring 2 becomes further larger than the torsion stress of the coil member forming the inner circumferential portion of the arc spring 2.

As explained above, according to the present invention, the arc spring 1 having a predetermined curvature radius is further flexed and retained in the spring retaining space 3, initial stress is applied to the coil member configuring the arc spring 2. According to such a structure, with the arc spring 2 being compressed, the torsion stress at the attachment diameter, the torsion stress of the coil member forming the inner circumferential portion of the arc spring 2, and the torsion stress of the coil member forming the outer circumferential portion of the arc spring 2 can be caused to match with each other. In this case, the arc spring 1 has a larger curvature radius than that of the spring retaining space 3. Moreover, the arc spring 2 has the curvature radius made smaller than that of the arc spring 1, and is retained in the spring retaining space 3 having a predetermined curvature radius.

According to the present embodiment, the arc spring is retained in the spring retaining space having a predetermined curvature radius or is held by a spring holder and spring receiver, and thus the torsion stress of the coil member produced when the arc spring 2 is compressed is made uniform across the whole arc spring 2. Instead of manufacturing an arc spring satisfying a predetermined condition, a normal arc spring may be flexed to some level to apply torsion stress with a negative sign to the coil member forming the inner circumferential portion of the arc spring.

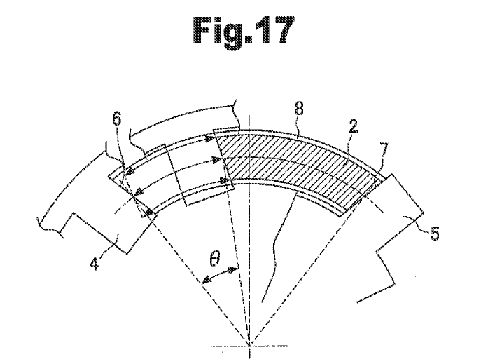

The arc spring 2 illustrated in FIG. 17 is retained in a spring retaining space 8 having a curvature radius of R₁, and held by a spring holder 4 and a spring receiver 5. In this case, torsion stress with a negative sign is applied to the coil member forming the inner circumferential portion of the arc spring 2. Furthermore, the inclination angle of a holding face 6 of the spring holder 4 and that of a receiving face 7 of the spring receiver 5 may be adjusted respectively, and the arc spring 2 may be held and compressed by the spring holder 4 and the spring receiver 5. According to such a structure, torsion stress of the coil member produced when the arc spring 2 is compressed can be also made uniform across the whole arc spring.

Moreover, by holding the arc spring 2 by the spring holder 4 and the spring receiver 5 without retaining the arc spring 1 in the spring retaining space 8 and without changing the curvature radius Rₐ of the arc spring 1, torsion stress with a negative sign may be applied to the coil member forming the inner circumferential portion of the arc spring 2. Next, by rotating the spring holder 4 by an angle θ relative to the spring receiver 5 to compress the arc spring 1, torsion stress of the coil member produced when the arc spring 2 is compressed may be made uniform across the whole arc spring.

In the above-explained embodiment, although the arc spring 1 employs a single-spring structure, the arc spring may employ a dual-spring structure in which another arc spring having a smaller outer diameter is fitted in the internal space of the arc spring 1. In this case, only the outer main arc spring may be the arc spring 1 of the present invention, and only the internal sub arc spring may be the arc spring 1 of the present invention. Furthermore, both of the outer main arc spring and the inner sub arc spring may be the arc spring 1 of the present invention.

1. An arc spring which has a predetermined curvature radius in a free condition and which has a free angle between lines that interconnect a center of the curvature radius and respective ends of the arc spring, wherein
a spring retaining space that retains the arc spring has predetermined curvature radius and attachment angle,
the curvature radius of the arc spring is set to be larger than the curvature radius of the spring retaining space, and
the arc spring is flexed and retained in the spring retaining space, and thus the curvature radius of the arc spring becomes small and the attachment angle of the arc spring becomes large in comparison with those of the arc spring in a free condition, thereby applying torsion stress with a negative sign to a coil member forming an inner circumferential portion of the arc spring.

2. The arc spring according to claim 1,
wherein a spring holder and a spring receiver that depress both ends of the arc spring apply torsion stress with a negative sign to a coil member forming an inner circumferential portion of the arc spring.

3. The arc spring according to claim 1,
wherein torsion stress of the coil member forming the inner circumferential portion of the arc spring and torsion stress of the coil member forming an outer circumferential portion of the arc spring become consistent with torsion stress at an attachment diameter when the arc spring in the spring retaining space is compressed by a certain angle.

4. The arc spring according to claim 2,
wherein torsion stress of the coil member forming the inner circumferential portion of the arc spring and torsion stress of the coil member forming an outer circumferential portion of the arc spring become consistent with torsion stress at an attachment diameter when the arc spring in the spring retaining space is compressed by a certain angle.

5. A damper apparatus comprising:
a main body comprising a spring retaining space; and
a damper spring retained in the spring retaining space, and
the damper apparatus being configured to absorb impact torque, wherein
the damper spring comprises an arc spring,
the arc spring has a predetermined curvature radius in a free condition, and has a free angle between lines that interconnect a center of the curvature radius and respective ends of the arc spring,
the spring retaining space has predetermined curvature radius and attachment angle,
the curvature radius of the arc spring is set to be larger than the curvature radius of the spring retaining space, and
the arc spring is flexed and retained in the spring retaining space, and thus the curvature radius of the arc spring becomes small and an attachment angle of the arc spring becomes large in comparison with those of the arc spring in a free condition, thereby applying torsion stress with a negative sign to a coil member forming an inner circumferential portion of the arc spring.

6. The damper apparatus according to claim 5,
wherein when the arc spring in the spring retaining space is compressed by a certain angle by the impact torque, torsion stress of the coil member forming the inner circumferential portion of the arc spring and torsion stress of the coil member forming an outer circumferential portion of the arc spring become consistent with torsion stress at an attachment diameter.

7. The damper apparatus according to claim 5,
wherein a spring holder and a spring receiver that depress both ends of the arc spring apply torsion stress with a negative sign to a coil member forming an inner circumferential portion of the arc spring.

8. The damper apparatus according to claim 6,
wherein a spring holder and a spring receiver that depress both ends of the arc spring apply torsion stress with a negative sign to a coil member forming an inner circumferential portion of the arc spring.
